(19) United States
(12) Patent Application Publication
(10) Pub. No.: US 2014/0044247 A1
(43) Pub. Date: Feb. 13, 2014

(54) METHOD FOR PERFORMING SPECTRUM MANAGEMENT IN A SUBSCRIBER PREMISES NETWORK

(71) Applicants: Jochen Maes, Veerle (BE); Michael Timmers, Herent (BE); Mamoun Guenach, Machelen (BE)

(72) Inventors: Jochen Maes, Veerle (BE); Michael Timmers, Herent (BE); Mamoun Guenach, Machelen (BE)

(73) Assignee: ALCATEL-LUCENT, Paris (FR)

(21) Appl. No.: 14/003,035

(22) PCT Filed: Mar. 19, 2012
(86) PCT No.: PCT/EP12/54750

§ 371 Date: Sep. 11, 2013

(30) Foreign Application Priority Data
Mar. 29, 2011 (EP) 11305352.4

(51) Int. Cl. H04B 3/32

(52) U.S. Cl. CPC H04B 3/32
USPC 379/93.09

(57) ABSTRACT

A network includes an access link and a local area link. The access link and the local area link are interferingly coupled. A method for performing spectrum management in view of a constraint in the network includes quantifying interference between the access link and the local area link, determining a first spectral configuration for a first transmitter operating over the access link, and determining a second spectral configuration for a second transmitter operating over the local area link. The determining of the first spectral configuration and the determining of the second spectral configuration are performed such that the respective achievable channel capacities of the access link and the local area link meet the constraint.

### FIELD OF INVENTION

The present invention pertains to the field of spectrum management, more particularly to the field of applying spectrum management in a local area network, such as a subscriber premises network.

### BACKGROUND

It is known to apply spectrum management to wireless transmission systems and to digital subscriber line (DSL) systems. Subscriber lines are physically collocated in binders, in which a frequency and coupling length dependent amount of crosstalk will originate between the signals travelling over the respective lines. Just like multiple access or co-channel interference in wireless transmitters, DSL transmitters must therefore take into account certain spectral restrictions in order to coexist with other, similar or dissimilar systems. In an advanced form of spectrum management, the power spectral densities (PSDs) of multiple DSL transmitters are coordinated to e.g. achieve an increase in the aggregate bit rate available to these transmitters or even to decrease the total power to meet certain target rates.

### SUMMARY

The present invention is based on the insight that the presence of a local area network (LAN) at the premises of the subscriber influences and is influenced by the operational characteristics of this subscriber's DSL link. It is therefore an object of the present invention to jointly optimize the capacity and/or the power consumption of the access link and the local link(s).

In a first aspect of the present invention, there is provided a method for performing spectrum management in view of a predetermined constraint in a network comprising an access link and a local area link, the access link and the local area link being interferingly coupled, the method comprising: quantifying interference between the access link and the local area link; determining a first spectral configuration for a first transmitter operating over the access link; and determining a second spectral configuration for a second transmitter operating over the local area link; wherein the determining of the first spectral configuration and the determining of the second spectral configuration are performed such that the respective achievable channel capacities of the access link and the local area link meet the predetermined constraint.

In an embodiment of the method according to the present invention, the predetermined constraint comprises maximizing the weighted sum of the respective channel capacities of the access link and the local area link.

In an embodiment of the method according to the present invention, the predetermined constraint comprises maximising the lesser one of the respective channel capacities of the access link and the local area link.

In an embodiment, the method according to the present invention further comprises analyzing a topology of the network to determine the predetermined constraint.

In an embodiment of the method according to the present invention, the quantifying of the interference comprises: cycling the first transmitter through an active state and a passive state to determine a difference in received interference from the first transmitter; cycling the second transmitter through an active state and a passive state to determine a difference in received interference from the second transmitter; obtaining first information from a first receiver operating over the access link to determine a difference in received interference during the cycling of the second transmitter; and obtaining second information from a second receiver operating over the local area link to determine a received interference during the cycling of the first transmitter.

Here, a substantially passive state refers to a state in which the PSD is reduced or set to zero on at least a relevant fraction of the transmission bandwidth.

In a particular embodiment, the first transmitter and the second transmitter are comprised in a customer premises equipment, the quantifying of the interference being controlled by a processor comprised in the customer premises equipment, the processor being operatively coupled to the first transmitter and the second transmitter, and the processor being further configured to receive the first information from the first receiver and the second information from the second receiver.

In another particular embodiment, the quantifying of the interference is controlled by a network management apparatus, the network management apparatus being configured to control the first transmitter, the second transmitter, the first receiver, and the second receiver.

In a more particular embodiment, the network management apparatus controls at least one of the first transmitter, the second transmitter, the first receiver, and the second receiver through a TR-069 protocol exchange.

While the processor may reside in a the customer premises equipment that also comprises the access network termination and an in-home network termination, the processor may also quantify interference from and to access and in-home transceivers outside of the customer premises equipment. Likewise, the processor may control the configuration of access and in-home transceivers outside of the customer premises equipment.

According to another aspect of the present invention, there is provided a computer program configured for carrying out the method as described above.

According to another aspect of the present invention, there is provided a customer premises equipment for use in the method as described above.

According to another aspect of the present invention, there is provided a network management apparatus for use in the method as described above.

### BRIEF DESCRIPTION OF THE FIGURES

Some embodiments of apparatus and/or methods in accordance with embodiments of the present invention are now described, by way of example only, and with reference to the accompanying drawings, in which:

FIG. 1 illustrates a first exemplary topology of a network in which the invention may be used advantageously;

FIG. 2 illustrates a second exemplary topology of a network in which the invention may be used advantageously;

FIG. 3 illustrates an exemplary network with a spectrum manager according to the present invention; and

FIG. 4 provides a flow chart of an embodiment of the method according to the present invention.

### DESCRIPTION OF EMBODIMENTS

The skilled person will understand that any references to a home network in the present description are strictly exemplary and not intended to limit the scope of application of the present invention to residential settings. The invention is in fact also applicable to other settings in which an access link and a local area network link are present, including office, industry, hospitality, and educational settings.

The number of transceivers shown in the figures is chosen for illustrative purposes only, and does not limit the generality of the invention in any way. Operations described in relation to a given transceiver may apply, mutatis mutandis, to other transceivers in the network.

It is known to apply spectrum management to digital subscriber line (DSL) access systems. In an advanced form of spectrum management, the power spectral densities of multiple DSL transmitters are coordinated to achieve an increase in the aggregate bit rate available to these transmitters. Coordination can easily be achieved between DSL lines that originate from a common access node (digital subscriber line access multiplexer, DSLAM), because all the necessary information is centralized at that point. DSL systems based on discrete multi-tone (DMT) transmission, such as ADSL, VDSL, and their successors, are particularly suited for advanced spectrum management, because these systems allow per-tone power configuration (leading to a frequency decoupling of the optimization problem) and because they use a fixed symbol duration of 250 μs, which may be synchronized between lines (leading to a further decoupling of the optimization problem).

Certain LAN communication technologies for use in the home network (HN), such as HomePlug AV, G.hn and IEEE P1901, are known to mutually interfere with the twisted pairs used by DSL operators as they share some parts of the spectrum.

For example, G.hn technology can use the frequency band from close to DC up to 100 MHz while VDSL2 is only restricted to 30 MHz. As a result of the mutual interference, the attainable data rate of the copper access link is reduced by 20% to 50%. The problem is particularly notable in the downstream direction due to the near-far effect between the downstream transmitter and the home network transmitter: the DSL DS signal received at the customer premises is already attenuated by a certain amount that depends on the distance between the customer premises equipment (CPE) and the access node.

Not only the rate of the DSL line is impacted, but also the stability of the lines, because of the transient noise induced by the home network devices, which typically transmit intermittently.

On the other hand, for some legacy home network technology operating over a reduced frequency band, e.g. [0.30] MHz, crosstalk induced by DSL into the home network link may limit the capacity of the home network.

The present invention is inter alfa based on the insight that it is advantageous to have the spectra of both the access and in-home link jointly optimized. However, the present invention is also based on the realization that the spectrum management advantages of DMT-based DSL systems (frequency decoupling, time decoupling, and centralized management) are not applicable to a mixed DSL/home network environment. The present invention therefore introduces a novel common spectrum manager for both the access and the in-home link.

For example, the frequency decoupling that is present among DSL systems is not present among a mix of DSL and in-home systems. DSL uses DMT with filtering in the time domain, which corresponds to a “sinc” function in the frequency domain. The carrier spacing and filtering are such that the carrier frequency positions correspond to the zero crossings of the “sinc” functions of all other carriers. Therefore, the different sub-channels or tones are orthogonal and the transmit PSD at one tone does not cause significant inter-carrier interference into adjacent tones. In this way, the spectral optimization problem in DSL is decoupled over tones. Access and in-home systems use different carrier frequencies, and as such the optimization problem does no longer decouple over tones. One way to circumvent the issue is by adapting the optimization framework such that the inter-carrier interference can be modeled or estimated and added to the interference observed on a particular carrier. This means that the problem statement can no longer be decoupled over tones, leading to higher processing complexity. However, the higher processing complexity is tempered by the low number of disturbing lines. While in an access environment, typically tens of lines mutually interfere, the number of mutually interfering lines in the problem at hand is limited to one access link and one or a few in-home links. The increased complexity due to coupling over tones is therefore partly compensated by a reduced complexity in the number of lines. Alternative ways to circumvent the coupling over tones is to derive a PSD level on a larger bandwidth scale, e.g. optimize over a limited number of guide tones and interpolate to determine the PSD of the remaining tones, instead of per tone.

The common spectrum manager may reside within a CPE that integrates both the DSL and the home network chips, or could be part of a separate management platform in the access operator's network that talks to the in-home devices, e.g. through the TR-069 protocol. This protocol could allow the configuration of the overall transmit power, and certain aspects of the shape of the PSD, such as the application of spectral notches, amongst other things.

Two exemplary scenarios may be considered for approaching the interactions between a DSL access network and an in-home distribution network.

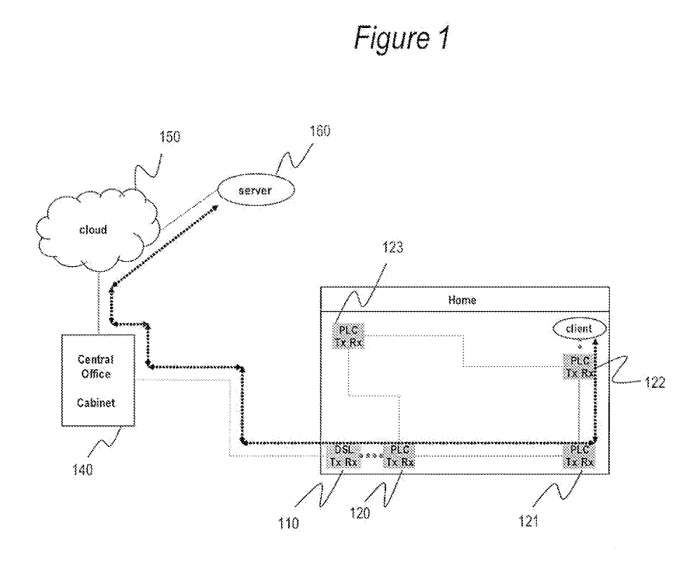

In the first exemplary scenario, illustrated in FIG. 1, the DSL access network, extending between an access node or central office 140 and a line termination 110 at the customer premises, collaborates with the in-home distribution network 120-123 to provide the user with a service, exemplified by server 160, offered from within the wide area network, a.k.a. the “cloud” 150. In this scenario, both networks share a common goal and spectral optimization can be used to achieve that common objective.

In the first scenario, the aggregated downstream and upstream net DSL data rate (on the path 140-110) should match the net data rate on the home network (in the illustrated example, the path 120-121-122), because the home network is an extension of the access network. Functionally, the goal is to avoid that either one of the DSL link or the home network presents a bottleneck for the data flow.

For completeness, server 160 and wide area network 150 are illustrated as being operatively connected to the access node 140. Clearly, the path 160-150-140 contributes to the quality of the end-to-end service delivery.

The net attainable DSL data rate depends on loop length, noise conditions and the configured parameter set. The net data rate in the home network depends on the corresponding in-home parameters. Both also depend on the mutual interference.

The method according to the present invention includes a step in which this mutual interference is quantified. This can be done by adapting the configuration on the devices and observing the effects. For instance, the crosstalk from the home network into the DSL link can be quantified by comparing the quiet line noise (QLN) or signal-to-noise ratio (SNR) when the home network device is turned off (or notched on the relevant frequencies) to when it is on. The difference between these measurements provides the crosstalk noise power from home network. The interference from the DSL link to the home network can be acquired in a similar way.

The required accuracy may allow further optimizations of the method of the invention. In an advantageous embodiment, it is sufficient to determine upper bounds on this interference.

Depending on the home networking technology, a direct SNR or QLN measurement may not be available. Nevertheless, an indirect measure is provided by reading out and comparing the throughput, i.e. the net data rate, when the DSL line is on and off (or notched), respectively.

Having the crosstalk channel state information, known spectrum balancing techniques can be applied for the joint optimization step. The target may be to maximize the minimum data rate of the DSL and home network link and/or to minimize the power. This target acts as a predetermined constraint for the optimization process. Depending on the chosen optimization algorithm, such spectrum balancing may lead to a frequency-dependent spectral shape in a format consistent with configurationally options of the in-home or access transmitter, or to simplified heuristic power back-off schemes.

As home network technologies may transmit intermittently, it is advantageous to store different operational profiles for the DSL link depending on whether the relevant home network transmitter is active or not. This requires obtaining information about the activity of the transmitter (by detection, or by receiving anticipatory information directly from the home network transmitter itself), and switching DSL profiles with a very low reaction time.

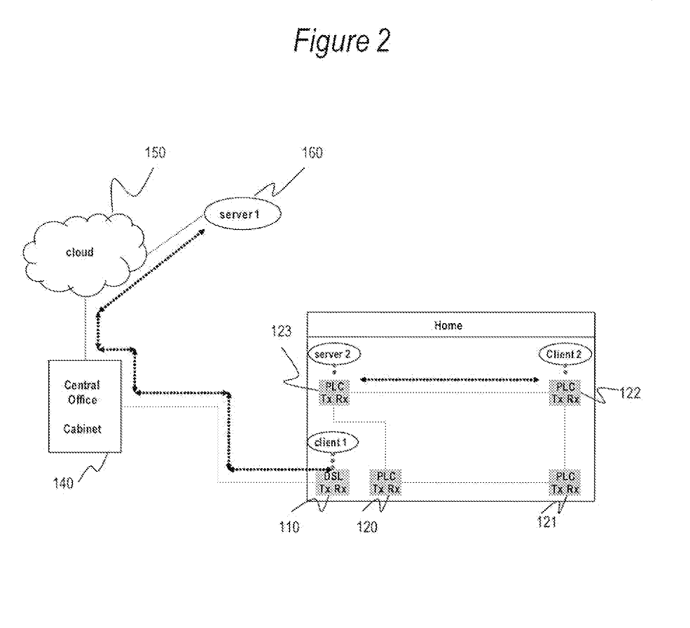

In the second exemplary scenario, illustrated in FIG. 2, the DSL access network, extending between an access node or central office 140 and a line termination 110 at the customer premises, provides a first service, while the in-home distribution network 123-122 provides a second (in-home) service, such as media distribution from an in-home media service, exemplified by the server shown along with transceiver 123. Other elements of FIG. 2 correspond to the elements with the same numbers in FIG. 1.

Accordingly, the home network also carries data that does not need to go out into (and does not come from) the access network. In that scenario, spectral optimization should balance the competing objectives of both networks.

The net data rate of the home network, when needed, can be allowed to be higher than the net DSL data rate. This modified constraint can be introduced in the general spectrum optimization framework described above through e.g. weight factors to trade off the competing targets. The weighting would relate to the importance of the end-to-end link from cloud to end-device(s) vis-á-vis the links between the different in-home end devices.

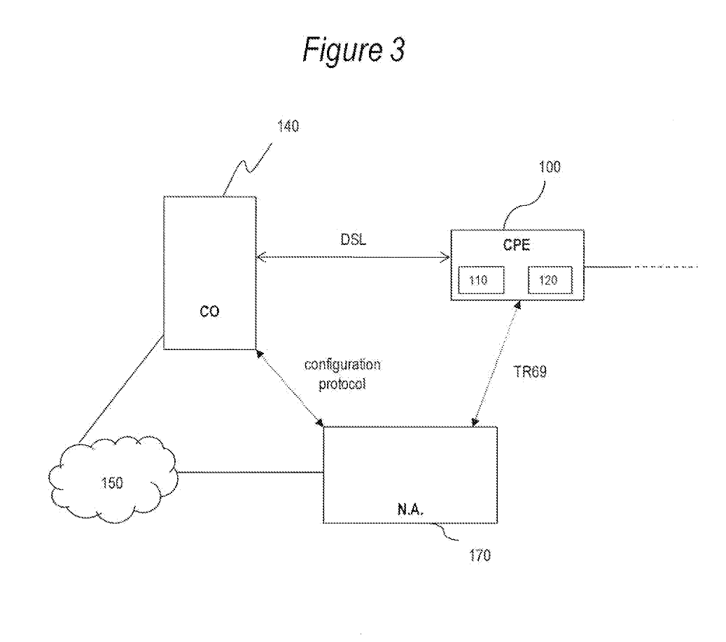

FIG. 3 conceptually illustrates how the method of the present invention may be carried out in part or completely from outside the home network. A network analyzer 170 is operatively connected to one or more of the access node 140 and the customer premises equipment 100 via a network 150, preferably by means of a remote configuration protocol. In applicable cases, TR-069 may be used as the remote configuration protocol.

Without loss of generality, the customer premises equipment 100 comprises a first transceiver 110 for interacting with the DSL line and a second transceiver 120 for interacting with the LAN. In order to carry out the method of the present invention, the customer premises equipment 100 may be instructed by the network analyzer 170 to selectively activate the transceivers operating on the various links, and to assess a measure of the mutual interference as described above.

The customer premises equipment 100 may also act as a proxy for other LAN transceivers 121-123 in the LAN, which may be included in the method of the present invention. For this purpose, the customer premises equipment 100 may be required to relay management messages from and to the network analyzer 170, optionally translating between the protocol used by the network analyzer 170 (e.g., TR-069) and a different management protocol used inside the LAN.

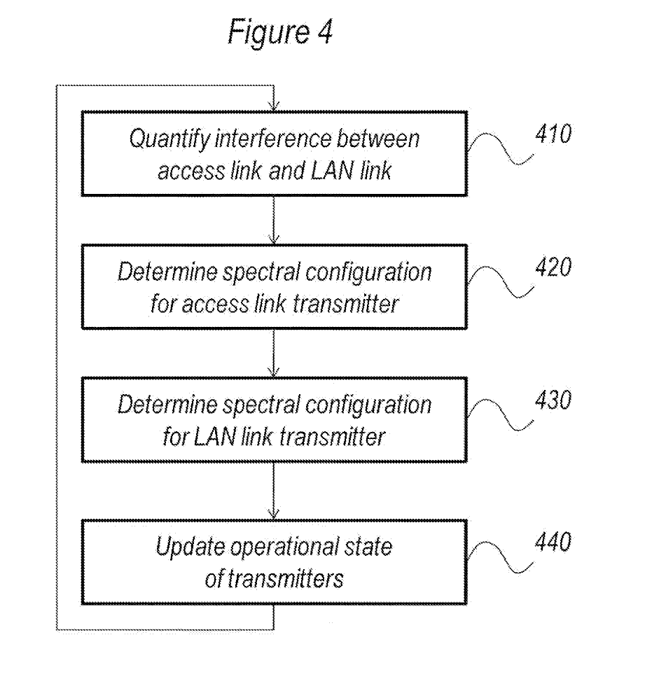

The method of the present invention is further conceptually illustrated by the flow chart of FIG. 4. Although the different process steps illustrated in FIG. 4 are shown in a certain order, this should not be taken to imply that the chosen order is necessary to carry out the invention. As will be clear from the description below, certain steps may be reordered or even omitted without leaving the scope of the invention.

In a preliminary step (not shown) the method of the present invention may include determining the type of configuration that needs to take place and the resulting performance constraints, i.e. an configuration of the type described above in connection with the first scenario, or a configuration of the type described above in connection with the second scenario. The step of quantifying the mutual interference between access link and LAN link 410 may accordingly include a sub-step of checking whether the end-to-end link, or each of the individual links, meets the predetermined performance requirements, as the case may be.

In the next step or steps, the desired spectral configuration for the access link transmitter is determined 420 and/or the desired spectral configuration for the LAN link transmitter is determined 430, according to a known spectrum allocation algorithm and in view of the constraints determined before. The spectrum allocation algorithm may be chosen so as to simply meet the predetermined constraints, if possible, or to also optimize a certain utility function (e.g., end-to-end throughput or throughput of a given link).

In a subsequent step 440, the updated configuration parameters are imposed on the affected transmitter(s).

As indicated by the arrow returning from step 440 to step 410, the process can be repeated periodically, to take a dynamically varying interference environment into account. Alternatively or additionally, the process may be repeated asynchronously upon the occurrence of specific events, such as the addition or removal of a transceiver in the relevant part of the network.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

1. A method for performing spectrum management in view of a predetermined constraint in a network comprising an access link and a local area link, said access link and said local area link being interferingly coupled, said method comprising:
quantifying interference between said access link and said local area link;
determining a first spectral configuration for a first transmitter operating over said access link; and
determining a second spectral configuration for a second transmitter operating over said local area link;
wherein said determining of said first spectral configuration and said determining of said second spectral configuration are performed such that the respective achievable channel capacities of said access link and said local area link meet said predetermined constraint.

2. The method of claim 1, wherein said predetermined constraint comprises maximizing the weighted sum of said respective channel capacities of said access link and said local area link.

3. The method of claim 1, wherein said predetermined constraint comprises maximizing the lesser one of said respective channel capacities of said access link and said local area link.

4. The method of claim 1, further comprising analyzing a topology of said network to determine said predetermined constraint.

5. The method of claim 1, wherein said quantifying of said interference comprises:
cycling said first transmitter through an active state and a substantially passive state to determine a difference in received interference from said first transmitter;
cycling said second transmitter through an active state and a substantially passive state to determine a difference in received interference from said second transmitter;
obtaining first information from a first receiver operating over said access link to determine a difference in received interference during said cycling of said second transmitter; and
obtaining second information from a second receiver operating over said local area link to determine a received interference during said cycling of said first transmitter.

6. The method of claim 5, wherein said first transmitter and said second transmitter are comprised in a customer premises equipment, said quantifying of said interference being controlled by a processor comprised in said customer premises equipment, said processor being operatively coupled to said first transmitter and said second transmitter, and said processor being further configured to receive said first information from said first receiver and said second information from said second receiver.

7. The method of claim 5, wherein said quantifying of said interference is controlled by a network management apparatus, said network management apparatus being configured to control said first transmitter, said second transmitter, said first receiver, and said second receiver.

8. The method of claim 7, wherein said network management apparatus controls at least one of said first transmitter, said second transmitter, said first receiver, and said second receiver through a TR-069 protocol exchange.

9. A computer program configured for carrying out the method of claim 1.

11. A network management apparatus for use in the method of claim 7.
